(19) United States
(12) Patent Application Publication
(10) Pub. No.: US 2012/0047095 A1
(43) Pub. Date: Feb. 23, 2012

(54) METHODS AND SYSTEMS FOR SELLING DIGITAL PHOTOGRAPHY SERVICES IN COMBINATION WITH A SINGLE-USE DIGITAL CAMERA

(75) Inventor: Werner KRACHTUS, Bechtsrieth (DE)

(73) Assignee: MOTIONDRIVE AG, Neustadt a.d. Waldnaab (DE)

(21) Appl. No.: 12/859,231

(22) Filed: Aug. 18, 2010

(51) Int. Cl. G06Q 50/00

(52) U.S. Cl. 705/500

(57) ABSTRACT

The present disclosure comprises a system for offering digital photography services in combination with a single-use digital camera that includes a provider and a distribution system. One or more cameras are offered and provided by the provider in combination with digital processing services for processing digital pictures and/or a product, e.g., a printout of the photographs, a photobook, a recording medium such as DVD, CD with print data of the photographs, etc.

### BACKGROUND

The application relates to methods and systems of providing digital photography services to a user, wherein the digital photography services may include at least one of digital photography processing services and a product based on the photographs taken by the user and returned to the provider.

Conventional single-use or disposable cameras have been available in the market for quite a long time. The cameras may be sold in any kind of shop or outlet location.

They are simply constructed, comprise simple components and are relatively cheap. Usually, single-use or disposable cameras are box cameras with a roll of film installed. Most of them use focus free lenses. Usually they have an inbuilt flash light.

Often they are distributed and used at particular occasions such as celebrations or weddings. There are also cameras available having a watertight housing. They may be used under water for underwater photography while snorkeling or diving. The cameras are particularly popular in situations where a reusable camera would be easily stolen or damaged.

After taking a predetermined number of photographs the whole camera is sent to a laboratory for processing, i.e., for developing the film and producing photographs. Because the film cannot be changed the housing is opened in the laboratory. After developing the film the photographs are sent back to the user. The opened cameras are usually disposed, only some of them are recycled, i.e., refilled with film and resold.

However, although the cameras are cheap and handling is easy, there are some serious drawbacks. Due to the use of cheap components, the quality of the photographs is not satisfactory. Furthermore, environmental aspects are not considered in this system as the camera may be made from different materials which may not be separated easily. Moreover, users may want to have more flexibility with respect to the products they obtain and more influence on the design of the product.

It is an object of the present disclosure to solve these problems, namely, to increase the quality of single-use cameras, to consider environmental aspects, and to provide customized products.

### SUMMARY

A method of providing digital photography services to a user according to the present disclosure may comprise a provider offering in combination a. a digital camera or digital camcorder for taking photographs or film sequences during a single-use phase; and b. at least one of digital photography processing services and a product based on the photographs taken by the user and returned to the provider.

The price for an offer (package) may substantially correspond to the price of the services/products included in the offer. However, the services/products included in the offer may only be claimed after returning the camera or camcorder to the provider. Thus, the price paid for the package before claiming the services/products may include in the offer a deposit for the camera. Therefore, there may be a high incentive to return the camera to the provider after a single-use phase. The camera may be left to the user free of charge (or for a certain amount for renting the camera) for a single-use range. The provider may “lend” the camera to the user when selling the package upon a deposit which is the price for the services. It may be a feature of the present disclosure that the provider does not make a loss even when the user keeps the camera, hacks the camera etc. The value of the camera/camcorder and the value of the services/products may substantially correspond. Small variations of the price, e.g., for compensating for administrational cost, additional charge for risk of having to repair or replace cameras, etc., may be within the scope of the present disclosure. However, the user may have the feeling that he does not pay at all for the camera, but only for the services which he converts in exchange for the camera after his/her particular single-use phase.

Another aspect of the present disclosure is that the provider of the camera/camcorder may also be the provider of the services/products acquired together with the camera/camcorder. In conventional systems, a disposable camera could be sent to any laboratory for developing the film and the laboratory likely charged extra for their services. In the present disclosure, selling the package may include providing a camera on a loan basis and selling digital photography services like printing books. All the steps may be carried out and administered by the same provider (i.e., the system and method may be a closed circuit). A single-use cycle system and method may be provided, wherein the cameras circulate to be used during single-use cycles. The plurality of cameras may be circulated in the closed circuit. For example, a first part of the plurality of cameras may be distributed among another plurality of users taking photos in their particular single-use phase. Another part of the plurality of cameras may have been returned from users to the provider for producing selected items or for carrying out selected services. Another part of the plurality of cameras may have been reset for another single-use phase and offered in a shop or in any other sales location to customers who may be interested in acquiring the package of camera and other products/services. In the closed circuit, there may be just a single payment transaction, for example, when the user buys the package.

Furthermore, the method may combine services and advantages of single-use cameras and digital photography services, e.g., ordering a photobook, in a very simple manner. A user may make a decision about the product when buying the package, e.g., when there is a choice of different packages for different services, he/she may make a decision when returning the camera to the provider by filling in a order card, and/or after retrieving (and selecting/processing) the data in the provider's access area in a global network.

The single-use phase may be defined by a restriction of the number of photographs to be taken with the camera or the exposure time for film sequences to be taken with the camcorder. The digital camera or the digital camcorder may have a limited capacity of exposures and recording time, respectively, during a single-use phase. The camera may be a single-use camera or a reusable camera having a limited number of exposures to be taken during a single-use stage or a limited recording time for film sequences to be taken during a single-use stage. In embodiments of the present disclosure, the capacity of the camera/camcorder may be limited by the charge state of the power source, e.g., the accumulator, battery, rechargeable battery, etc. As long as the power source is charged, exposures and films may be taken. If the charge state is “empty” the camera may have to be returned because the camera may be configured that the user is not enabled to re-charge the power source or change the battery. For example, the battery may be integrated within the housing of the camera without access for the user. The power source and the other technical components may be encapsulated in the housing. In some embodiments of the present disclosure, a set of power sources that are particularly suitable and fitting in the camera may be provided at the time of acquiring the camera.

Furthermore, in some embodiments, all the cameras circulating in the closed circuit of the system/method according to the present disclosure may include an ID chip, e.g., RFID chip, or any other identification device such that the pictures taken and returned to the provider by a particular user can be unambiguously attributed to the user. As pictures may be considered very private and personal it is important to avoid any confusion of users and picture sets. An ID chip which is connected with the camera may allow identifying a set of image data when the camera is returned to the provider until the product is sent to the user. The system may be configured such that an order form filled in by a user (or any personal data, e.g., name, address, etc., provided by the user) comprises a first code and the ID chip comprises the same or another code which is attributed to the first code. Thus, customer/user data and a camera returned by this particular customer/user may always be attributed to the personal data of the user even though during the technical process the camera may be separated from the order form or from the data provided by the user.

In some embodiments of the present disclosure, the digital camera or the digital camcorder may be a multi-use camera and a multi-use camcorder, respectively, which may be used in several subsequent single-use stages/phases, i.e., in several subsequent cycles of a single-use application. Thus, the quality of the components may be improved compared with disposable cameras. Furthermore, an improvement may be achieved by digital technology and processing. Furthermore, “recycling” may be very easy because it is accomplished by simply providing memory space for the next single-use stage. This can be done by deleting data from a memory or by resetting the camera.

In some embodiments, the digital camera or the digital camcorder may comprise a blocking for preventing users from transferring data from a memory of the camera and camcorder, respectively, to an external memory.

In some embodiments, the blocking may comprise a non-detachable mechanical blocking preventing access to a link or an interface of the camera and camcorder, respectively, or a software solution preventing transferring usable data from the camera and camcorder, respectively, to an external memory.

A software solution may be implemented in the logical circuit of the camera. It may deny user access to the internal memory of the camera or it may encode exposure data stored in the internal memory of the camera. Only the provider may be able to deactivate the blocking or to decode the data.

A hardware solution may comprise a mechanical blocking of a link or an interface provided in the camera. Whereas the internal memory of the camera may be blocked against access by the user, the provider may have a “key” to unlock the download functionality. For example, the “key” may be a tool for breaking or opening the housing of the camera in order to obtain access to the memory card, a link, an interface, etc. However, the housing may just be an encapsulation which may be opened by applying force, or by applying a special tool for opening e.g., screws or bolts to open the housing. Another possibility is that the housing may be destroyed by the provider in order to be able to access the memory and the housing may be replaced for the next single-use stage. I.e., the housing may be a single-use housing, whereas the other components of the camera may be multi-use components.

In some embodiments of the present disclosure, the method may include providing in said combination a voucher for claiming said photography processing services and said product.

The product may include that a photograph taken is provided as data stored on a recording medium such as a DVD, a CD or online in a print format. Or the product may be printed matter, e.g., a photobook, an album, etc.

The digital camera and the digital camcorder, respectively, may be offered in a receptacle or together with a receptacle for receiving the digital camera and digital camcorder, respectively, after termination of the single-use phase, and returning it to the provider. After having taken pictures the user may return the camera to the provider. The receptacle may comprise a field, e.g., including a stamp, indicating that the correct postage has been paid (which may be included in the purchase price for the offer).

Payment of the combination may be effected at the time or before the time of handing over the camera and camcorder, respectively, to the user so that the user may not pay for the camera directly, but for the services/products included in the offer. The purchase price may be used as (or include) a deposit for the camera until it is returned to the provider (i.e., the user may have to return the camera or camcorder before claiming digital photography processing services and a product included in the offer).

The camera may have a functionality of taking photographs and film sequences. The offer may be adapted to this functionality by providing a camera which is configured for recording a combination of pictures and film sequences until a predetermined capacity is used.

The provider may provide in said combination a set (or plurality) of single-use digital cameras or a set of single-use digital camcorders.

The method may include providing in a network an access area for enabling the user to retrieve exposure data returned to the provider upon input of a user code. The user may access a global network such as the internet and log in an area provided by the provider. From there he/she may retrieve pictures. The user code may be included in the offered combination, i.e., it may be provided when the user acquires the package.

A system of providing digital photography services to a user may comprise a provider offering in combination a. a digital camera or digital camcorder for taking photographs or film sequences during a single-use phase; and b. at least one of digital photography processing services and a product based on the photographs taken by the user and returned to the provider; wherein the provider may have a camera distribution unit for distributing cameras in a distribution system, a receiving unit for receiving cameras returned by the users, a processing unit for processing exposure data provided by the users, and a memory for storing exposure data.

The offer may include a link for providing to a user access to a particular area of said memory upon entering an access code.

### BRIEF DESCRIPTION OF THE DRAWINGS

FIG. 1 illustrates a schematic view of a system according to the present disclosure.

FIG. 2 illustrates a flow chart showing a method according to the present disclosure.

### DETAILED DESCRIPTION

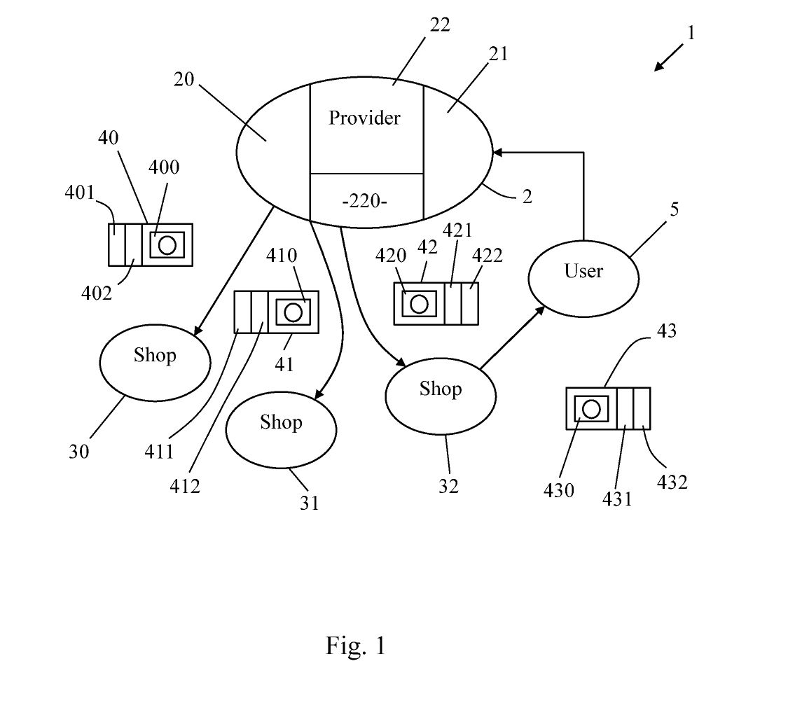

FIG. 1 shows a schematic view of a system 1 for offering digital photography services in combination with a single-use digital camera according to the present disclosure. The system 1 may comprise a provider 2 and a distribution system 3.

The provider 2 may have various functional units or departments 20, 21, 22. A camera distribution unit 20 may distribute digital cameras and/or digital camcorders 400, 410, 420 to a distribution system 3 (which may include shops 30, 31, 32). A receiving unit 21 may receive cameras returned by a user 5 to the provider, e.g., by post. A processing unit 22 (including a central memory 220) may process image data taken and provided by the users 5 by returning the cameras to the provider 2.

According to the present disclosure, the cameras 400, 410, 420, 430 may be offered and provided by the provider 2 in a combination 40, 41, 42, 43 with digital processing services for processing digital pictures and/or a product, e.g., a printout of the photographs, a photobook, a recording medium such as DVD, CD with print data of the photographs. The product may also be a downloadable print version of the photographs. Thus, the offer may include a package 40, 41, 42, 43 of a camera/camcorder (or a set of cameras/camcorders) 400, 410, 420, 430 with a claim for additional goods/services. The services and products that may be included in the offer are schematically indicated by vouchers 401, 411, 421 and 431 included in each of the packages 40, 41, 42, 43 which may entitle the user to claim the services/products included in the offer.

The cameras 400, 410, 420, 430 that may be included in the packages 40, 41, 42, 43 may be single-use cameras or camcorders in the sense that “single-use” refers to single use for a user in a particular single-use phase. The reason is that the number of pictures to be taken by a camera 400, 410, 420, 430 or the time for taking film sequences with a camcorder of a package 40, 41, 42, 43 may be limited. Also, it may not be possible for a user to download or transfer exposures stored on a memory card of a camera/camcorder to an external memory as with conventional multi-use cameras. This does not mean that the cameras or camcorders 400, 410, 420, 430 are necessarily disposable. The cameras or camcorders 400, 410, 420, 430 may be multi-use devices and they may be configured for repeatable single-use phase application. As soon as a single-use phase is terminated, i.e., the memory capacity has been used and there is no more memory capacity available, the camera may have to be reset in order to be used in a next single-use phase. Only the provider may be enabled and entitled to transfer data from the camera to an external memory and to reset the camera.

Furthermore, a return receptacle, e.g., an envelope, bag, pouch, or case 401, 411, 421, 431 may be included in the package 40, 41, 42, 43 to receive the camera after use, and to return it to the provider 2. The receptacle 401, 411, 421, 431 may include the postage for returning the receptacle 401, 411, 421, 431 from a user 5 to the provider.

The distribution system 3 may have a plurality of shops 30, 31, 32. The shops 30, 31, 32 (including various sales or distribution outlets) may sell the packages 40, 41, 42, 43. The price for a package 40, 41, 42, 43 may correspond to the price of the services/products included in the offer. However, the services/products included in the offer may only be claimed after returning the camera or camcorder 400, 410, 420, 430 to the provider. Thus, the price paid for the package before claiming the services/products may include in the offer a deposit for the camera. Therefore, there may be a high incentive to return the camera to the provider after a single-use phase. The camera may be left to the user free of charge (or for a certain amount for renting the camera) for a single-use range. The provider may lend the camera to the user when selling the package 40, 41, 42, 43.

Instead of shops, or in addition to shops, vending machines may be included in the system where the user can buy cameras or camcorders. The cameras may be sold with a choice of different products. For example, the camera may be bought in connection with a photobook, a photo album, a T-shirt, a cup or any other item including an illustration of one or a plurality of photos taken with the camera. There may be the possibility, however, to select the kind of service/product later.

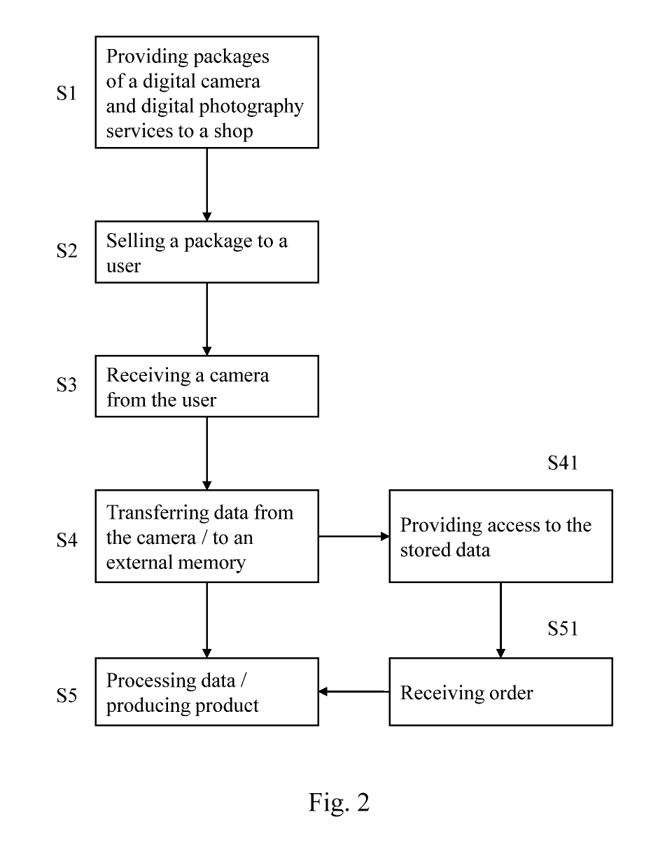

FIG. 2 illustrates a method of providing digital photography services and products to a user according to the present disclosure.

In a step S1, a provider may provide, e.g., to a shop, packages including at least one digital camera and/or digital camcorder, and digital photography services and/or the right to order digital photography products after returning the camera. A voucher may be provided together with the camera, either in written form or as a code. As described above, the cameras and camcorders, respectively, included in the package may have limitations with respect to the capacity and with respect to the transfer of data from the internal memory card of the camera to an external memory. In other words, the transfer may be blocked for the user such that only the provider may have a “key” to transfer data and to reset the camera for another single-use phase.

In a step S2, a package may be sold to a user. The user may pay for the package in the shop, e.g., in cash or by credit card. The payment may be simultaneously a deposit for the camera/camcorder and the purchase price for the services/products included in the package. Because the services/products may only be provided after the camera has been returned to the provider, the payment may be a deposit during the single-use phase and a purchase price after returning the camera to the provider. Thus, high quality components may be used for the camera resulting in high quality of the exposures.

In a step S3, the user may send the camera back to the provider after having taken pictures during the single-use phase. The provider may receive the camera from the user.

In a step S4, the provider may transfer the data relating to the exposures taken by the user from the internal memory card of the camera to an external memory. Because the internal memory of the camera may be blocked against access by the user, the provider may have a “key” to unlock the download functionality. The key may be any means to retrieve usable data from the memory. For example, the “key” may be a tool for breaking or opening the housing of the camera in order to obtain access to the memory card, a link, an interface, etc. The key may also be a code, e.g., for opening a cover part of the housing, for releasing a link or interface, or for decoding (encoded) data downloaded from the internal memory of the camera.

If image data are stored as encoded data in the memory of the camera, a further advantage may be that in case of loss of the camera there is no risk that the images may be seen by uninvolved persons.

In step S5, the data may be processed by the provider. For example, the provider may generate data of the photographs and send them to the user on a CD or DVD in a printable format, e.g., as a collection of photographs in a (virtual) book. The data may also be processed and a corresponding product, e.g., printed matter (hardware), a photobook or photo album may be provided and sent to the user.

In another embodiment of the present disclosure, additional steps S41 and/or S51 may be included. In step S41, which may be after step S4, the provider may provide the stored data to the user, e.g., by presenting the pictures in a protected area of a memory. The user may, via the internet, by inputting a code which he/she may have received when buying the package, enter the protected area. Then he/she may select pictures to be processed, select a format or product he/she would like to order, and make a corresponding order. Furthermore, the user may be enabled to pre-process the pictures, e.g., determine the size and arrangement in a photobook.

In step S51, the user may release a data set and give an order.

Then the method may proceed to step S5 where the released data may be processed by the provider and/or selected products may be produced.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, but neither require nor exclude two or more such elements. Further, ordinal indicators, such as first, second, or third for identified elements are used to distinguish between the elements; they do not indicate a required or limited number of such elements, and do not indicate a particular position or order of such elements unless otherwise specifically stated. Any aspect shown or described with reference to a particular embodiment should be interpreted to be compatible with any other embodiment, alternative, modification, or variance.

We claim:

1. A method of providing digital photography services to a user, comprising a provider offering in combination
a digital camera or digital camcorder for taking photographs or film sequences during a single-use phase; and
at least one of digital photography processing services and a product based on the photographs taken by the user and returned to the provider.

2. The method of claim 1, wherein said single-use phase is defined by a restriction of the number of photographs to be taken with the camera or the exposure time for film sequences to be taken with the camcorder.

3. The method of claim 1, wherein said digital camera or said digital camcorder is a multi-use camera and a multi-use camcorder, respectively, which may be used in several subsequent single-use phases.

4. The method of claim 1, wherein said digital camera or said digital camcorder comprises a blocking for preventing users from transferring data from a memory of the camera and camcorder, respectively, to an external memory.

5. The method of claim 4, wherein said blocking comprises a non-detachable mechanical blocking preventing access to a link or an interface of the camera and camcorder, respectively, or a software solution preventing transferring usable data from the camera and camcorder, respectively, to an external memory.

6. The method of claim 1, wherein said method includes providing in said combination a voucher for claiming said photography processing services and said product.

7. The method of claim 1, wherein said product based on the photographs taken is provided as data stored on a recording medium such as a DVD, a CD or online in a print format.

8. The method of claim 1, wherein said digital camera and said digital camcorder, respectively, is offered in a receptacle or together with a receptacle for receiving the digital camera and digital camcorder, respectively, after termination of the single-use phase, and returning it to the provider.

9. The method of claim 1, wherein payment of said combination is effected at the time or before the time of handing over the camera and camcorder, respectively, to the user.

10. The method of claim 1, wherein the user has to return the camera or camcorder before claiming digital photography processing services and a product included in said offer.

11. The method of claim 1, wherein said camera has a functionality of taking photographs and film sequences.

12. The method of claim 1, wherein said provider provides in said combination a set of a single-use digital cameras or a set of a single-use digital camcorders.

13. The method of claim 1, wherein said method includes providing in a network an access area for enabling the user to retrieve exposure data returned to the provider upon input of a user code.

14. The method of claim 13, wherein said user code is included in said offered combination.

15. A system of providing digital photography services to a user, comprising a provider offering in combination
a digital camera or digital camcorder for taking photographs or film sequences during a single-use phase; and
at least one of digital photography processing services and a product based on the photographs taken by the user and returned to the provider;
wherein the provider has a camera distribution unit for distributing cameras in a distribution system, a receiving unit for receiving cameras returned by the users, a processing unit for processing exposure data provided by the users, and a memory for storing exposure data.

16. The system of claim 15, wherein said offer includes a link for providing to a user access to a particular area of said memory upon entering an access code.
